(19) United States
(12) Patent Application Publication
(10) Pub. No.: US 2009/0316919 A1
(43) Pub. Date: Dec. 24, 2009

(54) ACOUSTIC CHARACTERISTIC CORRECTION METHOD AND APPARATUS

(76) Inventors: Yasuhiro KANISHIMA, Ome-shi (JP); Toshifumi Yamamoto, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,862

(22) Filed: May 28, 2009

(30) Foreign Application Priority Data
Jun. 24, 2008 (JP) 2008-164947

(51) Int. Cl. H04R 29/00

(52) U.S. Cl. 381/58

(57) ABSTRACT

According to one embodiment, an acoustic characteristic correction apparatus comprises a main module reproducing an audio signal and a remote controller includes a microphone, wherein the main module comprises a generation module generating a measurement signal, a receiver receiving a picked-up signal output from the microphone receiving the measurement signal, a detector module detecting acoustic characteristics based on the picked-up signal, a processor module obtaining correction characteristics based on the acoustic characteristics, and a correction module correcting the audio signal based on the correction characteristics.

### CROSS-REFERENCE TO RELATED APPLICATIONS

This application is based upon and claims the benefit of priority from Japanese Patent Application No. 2008-164947, filed Jun. 24, 2008, the entire contents of which are incorporated herein by reference.

### BACKGROUND

1. Field

One embodiment of the invention relates to correction of acoustic characteristics of a reproduction system including a sound field such as a shape of a room in which a listener takes his/her position.

2. Description of the Related Art

Since a sound reproduced from a loudspeaker is reflected at a ceiling, floor, wall, etc., in a room, reflected waves mutually interfere in phases. Extreme peaks or dips may occur at some listening positions, then a listener feels that something is wrong with his/her listening feeling due to the resulting peaks and dips.

Japanese Patent No. 3147618 (paragraphs [0018] to [0021]) discloses an acoustic characteristic correction apparatus according to a conventional technique for correcting acoustic characteristics of a reproduction system including such a sound field. This apparatus includes a main module, a remote controller, and a microphone, and the main module and the remote controller are connected to each other through a signal cable. The microphone is arranged at a listening position in a room in which music is reproduced, and is connected to a microphone input terminal of the main module. The main module generates a signal for measurement such as a band signal and a time delaying pulse signal, and the signal for measurement is reproduced from a loudspeaker to be used for reproduction through a power amplifier. The microphone picks up a reproduction sound of the signal for measurement to store a picked-up sound wave in a memory inside the main module. The measurement is performed at each position by moving the microphone to a plurality of points (e.g., five points) around a listening point as a center if necessary. Response characteristics are computed on the basis of the picked-up sound signals stored in the memory. The obtained response waves are displayed on a display unit of the remote controller as a bar graph, and the listener applies desired characteristics while viewing this display. Since the applied desired characteristics are overlapped on the obtained response characteristics to be displayed as a line graph and the corrected characteristics are also displayed as a line graph, the listener can recognizes which desired characteristics should be applied so as to obtain desired corrected characteristics in one glance and easily apply the desired characteristics. Calculating correction characteristics so that the response characteristics coincide with the desired characteristics and reproducing an audio signal for reproduction through the correction characteristics enable reproducing the audio signal in a state of adjustment for the desired characteristics.

However, it is needed to dispose the microphone at a measurement point for every measurement at each point, and connect the microphone to the main module through the cable, and the configuration of the acoustic characteristic correction apparatus becomes complicated. Further, the remote controller in order to apply the desired characteristics is also connected to the main module through the cable and the configuration of the apparatus is complicated.

In this way, the conventional acoustic characteristic correction apparatus cannot simply measure the acoustic characteristics in the sound field.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting an example of a configuration of an acoustic characteristic correction apparatus of an embodiment of the invention;

FIGS. 2A and 2B are exemplary views depicting an anterior half of a flowchart illustrating operations of the one embodiment of the invention; and

FIGS. 3A and 3B are exemplary views depicting a posterior half of a flowchart illustrating operations of the one embodiment of the invention.

### DETAILED DESCRIPTION

Various embodiments according to the invention will be described hereinafter with reference to the accompanying drawings. In general, according to one embodiment of the invention, an acoustic characteristic correction apparatus comprises a main module configured to reproduce an audio signal and a remote controller comprising a microphone, wherein the main module comprises a generation module configured to generate a measurement signal; a receiver configured to receive a picked-up signal transmitted from the remote controller, the picked-up signal being output from the microphone receiving the measurement signal; a detector module configured to detect acoustic characteristics based on the picked-up signal; a processor module configured to obtain correction characteristics based on the acoustic characteristics; and a correction module configured to correct the audio signal based on the correction characteristics. According to another embodiment of the invention, an acoustic characteristic correction method for an audio apparatus comprising a main module configured to reproduce an audio signal and a remote controller comprising a microphone, the method comprising generating, from the main module, a measurement signal; receiving, at the main module, a picked-up signal transmitted from the remote controller, the picked-up signal being output from the microphone receiving the measurement signal; detecting acoustic characteristics based on the picked-up signal; obtaining correction characteristics based on the acoustic characteristics; and correcting the audio signal based on the correction characteristics.

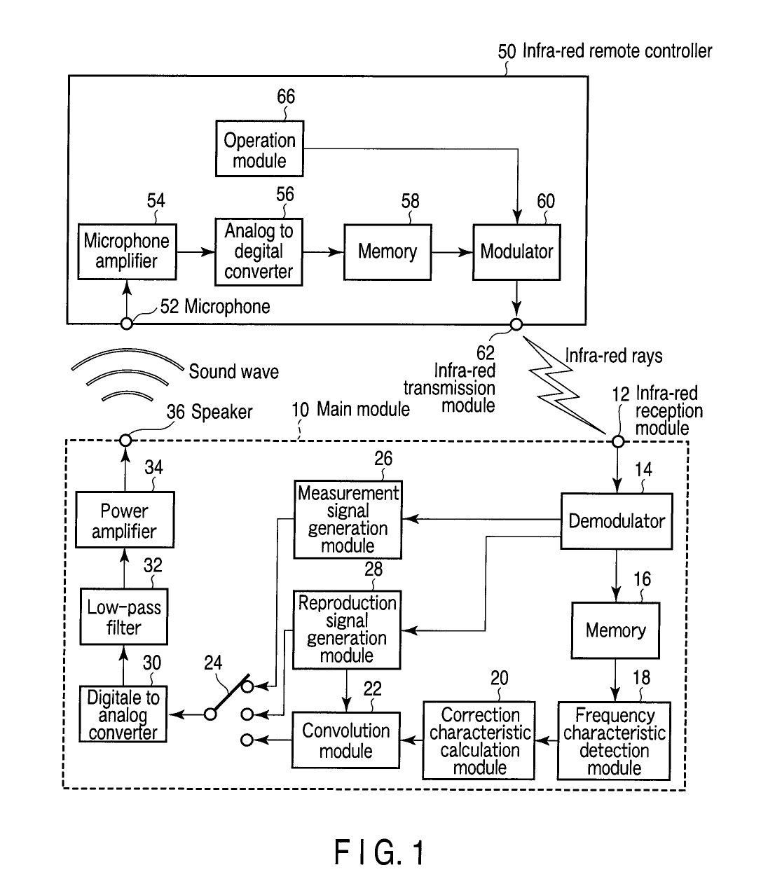

FIG. 1 shows a view depicting a configuration of an acoustic characteristic correction apparatus according to a first embodiment of the invention. The apparatus includes a main module 10 and an infra-red remote controller 50. The remote controller 50 is not limited to a remote controller using infra-red rays, and may be configured as another form such as a form using a short-range wireless communication system as long as wireless form. The main module 10 is an apparatus such as a television receiver and a stereo apparatus which have audio signal reproduction functions of reproducing audio signals to be heard by a listener. The remote controller 50 controls various operations of the main module 10, and transmits operation signals for an instruction of reproduction or stoppage, for adjustment volume, etc., to the main module 10 by means of infra-red communication. The main module 10 also has a function of reproducing to output a signal for acoustic characteristic measurement in a room (sound field) where the listener takes his/her position. The remote controller 50 has a built-in microphone for picking up a reproduced sound of the signal for measurement. The picked-up reproduced signal of the signal for measurement is transmitted from the remote controller 50 to the main module 10 through the infra-red communication. The main module 10 calculates the acoustic characteristics in the sound field, calculates the correction characteristics, and corrects the audio signal to be heard by the listener.

More specifically, the main module 10 includes an infra-red reception module 12 which receives a transmission signal from the remote controller 50. Since the transmission signal from the remote controller 50 has been modulated, a reception signal is supplied to a demodulator module 14 from a reception module 12, and the reception signal is demodulated. The transmission signal from the remote controller 50 is a digital signal. The transmission signal from the remote controller 50 includes a picked-up sound signal of the reproduced sound of the signal for acoustic characteristics measurement which has been picked up through the built-in microphone of the remote controller 50 and an operation instruction signal (acoustic characteristic correction start signal, etc.) The picked-up sound signal is supplied to a memory 16 from the demodulator 14 to be stored in the memory 16.

A frequency characteristic detection module 18 calculates frequency characteristics in the sound field from many picked-up sound signals stored in the memory 16. A correction characteristics calculation module 20 calculates correction characteristics for correcting peaks and dips included in the frequency characteristics in the sound field calculated by the frequency characteristic detection module 18. The correction characteristics are a tap coefficient of a finite impulse response (FIR) filter to be obtained through inverse Fourier transformation for a difference between the measured frequency characteristics and ideal frequency characteristics not including the peaks and dips. The correction characteristics are applied in a convolution module 22 including the FIR filter. When the convolution module 22 performs convolution processing with the correction characteristics, the convolution module 22 produces an audio signal having the ideal frequency characteristics of which the peaks and dips are cancelled.

Meanwhile, the acoustic characteristic correction start signal in the operation instruction signal obtained by the demodulator 14 is supplied to a generation module 26 of a signal for measurement to generate a signal for measurement for measuring the acoustic characteristics. The signal for measurement may use a monotone signal.

The main module 10 also includes a generation module 28 of a signal for reproduction which generates the audio signal to be heard by the listener, and generates an audio signal for listening in response to the operation signal from the remote controller 50. The generation module 28 may be a unit which reproduces an audio signal from a recording medium such as a CD, an MD, a DVD, a hard disk and a flash memory, or a module which separates the audio signal from a broadcasting signal. The audio signal for listening is supplied to a convolution module 22 to be corrected.

Any one of outputs from the convolution module 22, the generation module 26 of a signal for measurement, and the generation module 28 of the signal for reproduction is supplied to a digital-to-analog converter 30 through a selector 24. The reason why the output from the generation module 28 is supplied to the selector 24 as it is, is that the output may be reproduced without having to be corrected depending on the acoustic characteristics in the sound field. The reproduced sound of the output from the converter 30 is output through a low-pass filter 32, a power amplifier 34 and a loudspeaker 36.

The remote controller 50 includes a microphone 52 which picks up a sound wave output from the loudspeaker 36, and writes the picked-up sound signal output from the microphone 52 in a memory 58 through a microphone amplifier 54 and an analog-to-digital converter 56. The picked-up sound signal read from the memory 58 is transmitted to the main module 10 through a modulator 60 and an infra-red transmission module 62 to the main module 10. The remote controller 50 includes an operation module 66 including an acoustic characteristic correction button, a volume adjustment button, etc., an operation signal is output when the operation module 66 is operated, and the operation signal is transmitted to the main module 10 through the modulator 60 and the transmission module 62.

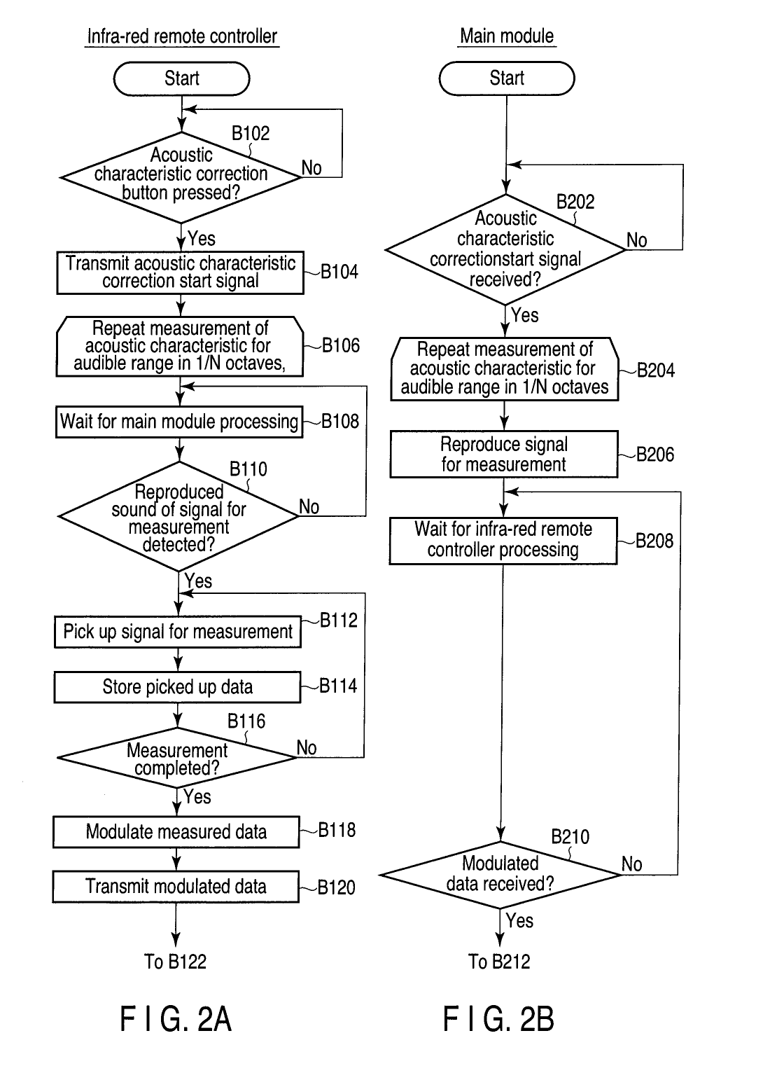

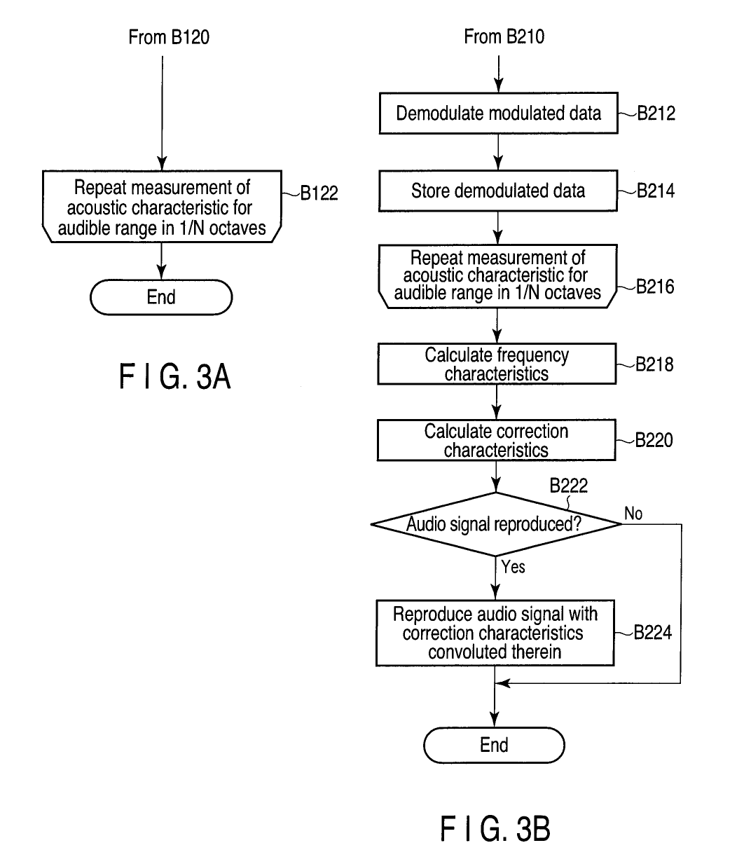

FIGS. 2A, 2B, 3A, and 3B show each flowchart illustrating an example of operations of the acoustic characteristic correction apparatus shown in FIG. 1. The flowchart on a remote controller side is shown in FIGS. 2A and 3A and a flowchart on a main module side is shown in FIGS. 2B and 3B. The operations mainly include (1) reproduction of the signal for acoustic characteristic measurement (main module 10); (2) pick-up of reproduced sounds and transmission of picked-up sound signals to the main module 10 (remote controller 50); (3) calculation of the frequency characteristics of the sound field (main module 10); (4) calculation of the correction coefficient (main module 10); and (5) correction of the audio signal to be heard (main module 10).

The listener listening to the audio signal to be reproduced by the main module 10 keeps the remote controller 50 at hand so as to operate the main module 10. Thereby, since the microphone may be in existence at the listening position of the listener without disposing the microphone at the listening point on purpose, the acoustic characteristics in the sound field may be measured at ease. If the operation module 66 of the remote controller 50 is operated and an acoustic characteristic correction button (not shown) is pressed (Yes, Block B102), the remote controller 50 outputs the acoustic characteristic correction start signal and this signal is transmit to the main module 10 through the infra-red rays (Block B104).

If the main module 10 receives the start signal from the remote controller 50 (Yes, Block 202), a signal for measurement (e.g., a monotone signal) of a certain frequency is generated. At this moment, the selector 24 selects the generation module 26 of a signal for measurement. The main module 10 outputs the signal for measurement as the reproduced sound from the loudspeaker 36 through the digital-to-analog converter 30, the low-pass filter 32, and the power amplifier 34 (Block B206).

The remote controller 50 waits for the reproduction of the signal for measurement, and if the reproduced sound of the signal for measurement is detected (Yes, Block B110), picks up the reproduced sound of the signal for measurement (block B112). The remote controller 50 stores picked-up sound data (amplitude) in the memory 58 (Block B114). For enhancing the precision of the picked-up sound data, the data of samples of a several number (e.g., at eight points) is averaged. It is determined whether or not the measurement at the eight points have been completed (Block B116). If it is determined that the measurement has not been completed, reproduced sounds at the next sampling points are picked up (Block B112), and picked-up sound data after averaging is stored in the memory 58 in Block B114. If the average at eight points has been obtained (Yes, Block B116), the measured data is modulated by the modulator 60 (Block B118), and the modulated data is transmitted to the main module 10 (Block B120).

After reproducing the signal for measurement in the main module 10 (Block B206), the main module 10 waits for the transmission of the modulated data from the remote controller 50 (Block B208), and if the modulated data has been received (Yes, Block B210), the modulated data is demodulated by the demodulator 14 (Block B212). The demodulated data is stored in the memory 16 (Block B214). Concluded, the measurement of the signal for measurement of one frequency is completed. Since it is necessary for the acoustic characteristics in the sound field to be measured in an entire frequency band of an audible range, the foregoing operations have to be repeated while varying the frequencies of the signals for measurement. As to one example, the main module 10 varies a frequency of a monotone signal for each 1/12 octave in a frequency band from 20 Hz to 20 kHz. On the remote controller side, as shown in Blocks B106 and B122, the operations from Block B108 to Block B120 are repeated, and on the main module side, as shown in Blocks B204 and B216, the operations from Block B206 to Block B214 are repeated.

On the remote controller side, when the repetition has been competed (Block B122), the operations end.

On the main module side, when the repetition has been completed (block B216), the frequency characteristic detection module 18 aligns the picked-up sound data (amplitude) of the monotone signals which have been measured for each 1/12 octave in the frequency band from 20 Hz to 20 kHz and stored in the memory 16 and normalizes the amplitude of the picked-up sound data then obtains the frequency characteristics on a frequency axis (Block B218). The correction characteristic calculation module 20 compares ideal frequency characteristics (flat [no peaks or dips] characteristics in the audible frequency band, or characteristics arbitrarily set by the listener) with the measured frequency characteristics, applies inverse Fourier transformation to the difference therebetween, and then, obtains the correction characteristics (a tap coefficient of the FIR filter). The correction characteristics are applied in the convolution module 22.

It is determined whether or not during reproduction of the audio signal to be heard (Block B222). If the determination is negative, the operations end. If the determination is affirmative, the convolution unit 22 applies convolution processing to the audio signal for listening generated from the generation module 28, obtains the audio signal having the ideal frequency characteristics in which the peaks and dips have been corrected, and the corrected audio signal is output as the reproduced sound from the loudspeaker 36 through the digital-to-analog converter 30, the low-pass filter 32 and the power amplifier 34 (Block B224). Since there is no need to correct the audio signal with no peaks and dips of the audio signal in the sound field even during reproduction of the audio signal to be heard, the audio signal from the generation module 28 may be reproduced as it is through the selector 24.

Thus, the listener at the listening position can easily measure the acoustic characteristics in the listening sound field, and if they exist in the acoustic characteristics, the listener can correct the peaks and dips by pressing the acoustic characteristic correction button on the remote controller 50. There is no need to dispose the microphone at the listening position and connect the microphone to the main module through the cable as mentioned in the description of the related art, and the operation is performed by simply pressing the button of the remote controller. Further, since the remote controller is a wireless remote controller, it is not necessary to connect the remote controller and the main module to each other through the cable, and it is easy to connect and operate the remote controller.

According to the embodiment, it is considered for the remote controller 50 to be surely present near the listener, and the microphone is built in the remote controller 50. The remote controller 50 of the embodiment differs from a usual remote controller in a point that the remote controller 50 has the built-in microphone 52 and microphone amplifier 54, and other than this point, there is no different from a general-purpose remote controller attached to the main module 10. The additional microphone 52 and the microphone amplifier 54 do not impose burden on an improvement of the remote controller 50 in the cost and size. In consideration a memory capacity, a data communication quantity, a battery lord, etc., as regards partial responsibility between the remote controller 50 and the main module 10, the processing in the remote controller 50 is limited to make measured data as small as possible in size so as to be stored in the built-in memory 58. The measured data is transmitted to the main module 10 through the infra-red rays, the calculation of the frequency characteristics (acoustic characteristics in the sound field) and the calculation such as correction characteristic calculation of which the processing load is heavy is processed in the main module 10 and then the acoustic characteristic correction apparatus can perform the acoustic characteristic correction (cancellation of peaks and dips) without posing an impact on component costs. Since the acoustic characteristics differ in listening position, and also differ in an environmental change in temperature and humidity, correcting a change in listening environment in response to the change produces a big advantage.

As mentioned above, merely operating the remote controller by the listener enables automatically correcting the acoustic characteristics to optimum acoustic characteristics corresponding to an environment for easy listening.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

For instance, while the aforementioned explanation has been described in the case where the signal for measurement is the monotone signal, the invention is not limited to this case, and a white noise, a band noise and a time stretched pulse (TSP) with a relatively large data size can be used.

What is claimed is:

1. An acoustic characteristic correction apparatus comprising:
a main module configured to reproduce an audio signal and a remote controller comprising a microphone, wherein
the main module comprises:
a generation module configured to generate a measurement signal;
a receiver configured to receive a picked-up signal transmitted from the remote controller, the picked-up signal being output from the microphone receiving the measurement signal;
a detector module configured to detect acoustic characteristics based on the picked-up signal;
a processor module configured to obtain correction characteristics based on the acoustic characteristics; and
a correction module configured to correct the audio signal based on the correction characteristics.

2. The apparatus of claim 1, wherein the remote controller further comprises:
a transmitter configured to transmit the picked-up signal from the microphone to the main module.

3. The apparatus of claim 1, wherein
the generation module is configured to generate measurement signals differing in frequency; and
the detector module is configured to detect the acoustic characteristics based on picked-up signals of the measurement signals.

4. The apparatus of claim 3, wherein
the detector module comprises a memory configured to store the picked-up signals of the measurement signals, and is configured to detect the acoustic characteristics by aligning the picked-up signals read out from the memory in a frequency axis, and by normalizing an amplitude of the picked-up signals.

5. The apparatus of claim 3, wherein
the transmitter is configured to average the picked-up signals and transmit an averaged signal.

6. The apparatus of claim 1, wherein
the measurement signal comprises a monotone signal with a plurality of frequencies in audible frequency ranges; and
the remote controller comprises:
a transmitter configured to transmit an amplitude of the picked-up signal from the microphone to the main module.

7. The apparatus of claim 1, wherein
the processor module is configured to obtain a correction coefficient by calculating inverse Fourier transformation of a difference between the detected acoustic characteristics and ideal acoustic characteristics; and
the correction module is configured to perform convolution of the audio signal based on the correction coefficient.

8. An acoustic characteristic correction method for an audio apparatus comprising a main module configured to reproduce an audio signal and a remote controller comprising a microphone, the method comprising:
generating, from the main module, a measurement signal;
receiving, at the main module, a picked-up signal transmitted from the remote controller, the picked-up signal being output from the microphone receiving the measurement signal;
detecting acoustic characteristics based on the picked-up signal;
obtaining correction characteristics based on the acoustic characteristics; and
correcting the audio signal based on the correction characteristics.

9. The method of claim 8, further comprising:
transmitting the picked-up signal from the remote controller to the main module.

10. The method of claim 8, further comprising:
generating measurement signals differing in frequency; and
detecting the acoustic characteristics based on picked-up signals of the measurement signals.

11. The method of claim 10, wherein the main module comprises a memory configured to store the picked-up signals of the measurement signals, and
the detecting comprising aligning the picked-up signals read out from the memory in a frequency axis, and normalizing an amplitude of the picked-up signals.

12. The method of claim 10, further comprising:
averaging the picked-up signals; and
transmitting an averaged signal from the remote controller to the main module.

13. The method of claim 8, wherein the measurement signal comprises a monotone signal with a plurality of frequencies in audible frequency ranges, and the method further comprising:
transmitting an amplitude of the picked-up signal from the microphone to the main module.

14. The method of claim 8, wherein the obtaining comprises performing inverse Fourier transformation of a difference between the detected acoustic characteristics and ideal acoustic characteristics; and
the correction comprises performing convolution of the audio signal based on the correction coefficient.
